(19) United States
(12) Patent Application Publication
(10) Pub. No.: US 2005/0155963 A1
(43) Pub. Date: Jul. 21, 2005

(54) Defrosting device

(76) Inventor: Jonathan Sage, Pringy (FR)

Correspondence Address: CANTOR COLBURN, LLP, 55 GRIFFIN ROAD SOUTH, BLOOMFIELD, CT, 06002, US

(21) Appl. No.: 10/503,193

(22) PCT Filed: Feb. 3, 2003
(86) PCT No.: PCT/FR03/00327

(30) Foreign Application Priority Data
Feb. 4, 2002 (FR) 02/01368

(51) Int. Cl. H05B 3/02

(52) U.S. Cl. 219/229; 219/227

(57) ABSTRACT

The invention concerns a portable device for defrosting surfaces covered with frost or ice. The invention provides a device for defrosting frosted surfaces economically, cleanly and without risk of further frosting following previous scraping. By means of its shell (1), it generates a chamber between the windscreen and the device, where the temperature is sufficiently heated to melt the frost. The temperature is raised beneath the shell (1) through a heating element (6) mounted in a protective slide (4) by two heat-resistant cover plates (5 and 10). The combination of said system with a flexible scraper blade (3), arranged perpendicular to the forward moving direction (12) enables removal of the melted frost or ice residue. The combination of a heated bubble (1 and 6) and a scraper blade (5 and 10) on the same side and positioned to operate in the same direction enables de-icing in one single passage over the entire width of the device.

This invention concerns a portable device for defrosting surfaces covered with frost or ice.

This layer of frost is traditionally eliminated by scraping with a special scraper, however this technique leaves a deposit that can re-freeze to form a second patch of frost that must once again be scraped. Another process uses an anti-freeze aerosol that, as the name implies, eliminates the frost when it is applied to the layer of frost to be eliminated. This aerosol can only be used a few times and sometimes releases toxic gasses into the atmosphere. Furthermore, as these aerosols are consumed quickly, having to keep purchasing more becomes costly.

The device according to the invention presented herein below makes it possible to eliminate all the problems cited in the preceding list. It has a heating element placed beneath a shell that, due to its bell shape, retains heat and saves energy. A flexible scraper blade placed perpendicular to the direction of movement, clamped between the shell and a protective slide, that wipes away the frost melted by the heating element. The water is evacuated by the scraper blade, which leaves behind it a dry window where there is no more water or any deposit that might re-freeze. This device can be re-used at will as long as it is in good condition from an electrical and structural standpoint. The device uses only electricity for the heating element and does not release any toxic substances and no gasses except for water vapor.

According to the particular modes of embodiment:
The power can be supplied by one or more accumulators placed in the handle or in any other location that can accommodate this/these electrical accumulator(s) that can be recharged using the car's cigarette lighter outlet or from the mains (conventional voltage)
When the parts are made of plastic material, the shell and the handle are molded in one piece via injection.
The protective slide, in the case where the part is made of plastic material, is to be injection molded.
The handle may be replaced by an accumulator also serving as a handle, but that at the same time supplies the electric power necessary for the operation of the device. The handle-accumulator is also rechargeable via the mains (conventional voltage) or the electrical system of vehicles.

The appended drawings illustrate the invention:

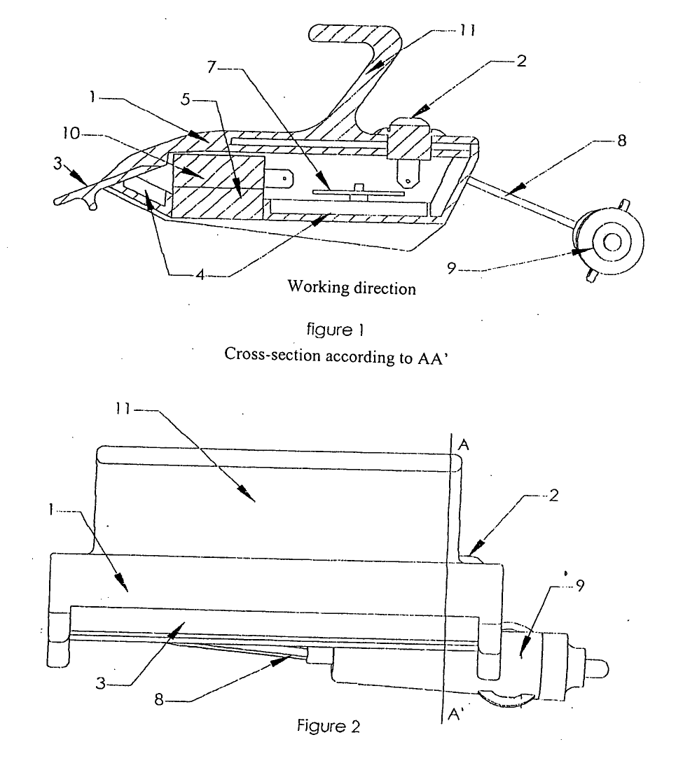

FIG. 1 represents the device according to the invention in cross-section.

FIG. 2 is a front view of the device according to the invention.

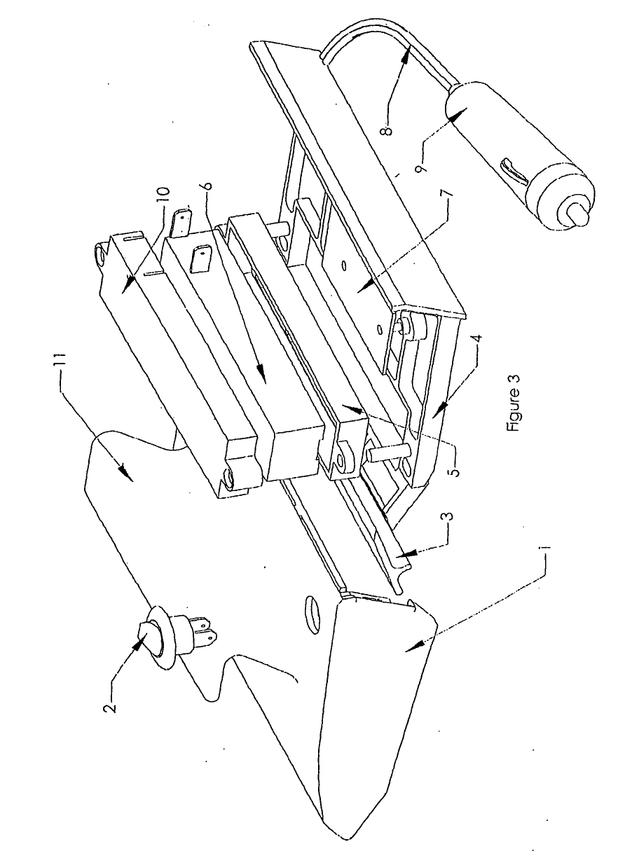

FIG. 3 is an exploded view of the device according to the invention according to the assembly axes.

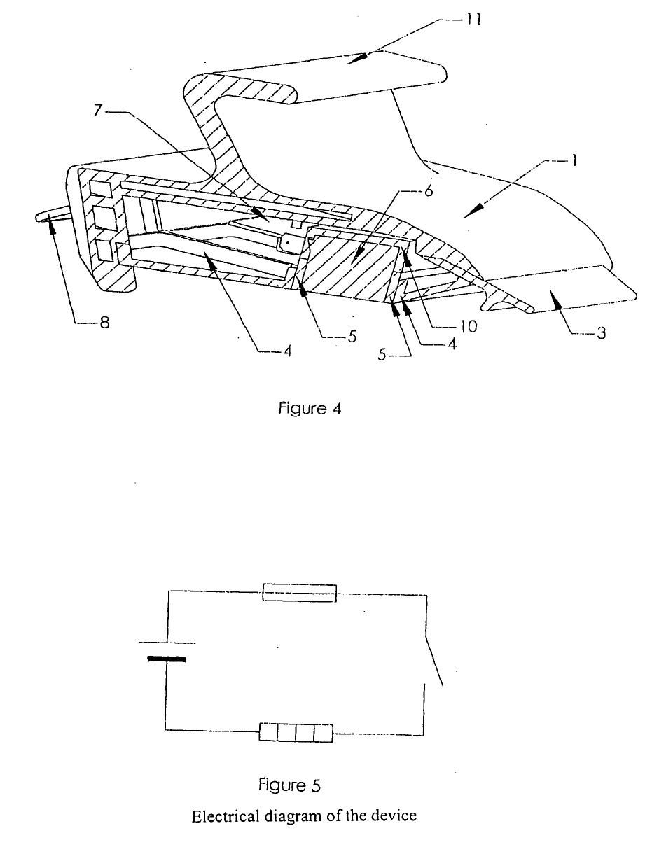

FIG. 4 is a three-quarter sectional view of the device according to the invention.

FIG. 5 shows the electrical circuit of the device according to the invention.

In reference to these drawings, the device comprises a handle (11) attached to a shell (1) and a protective slide (4) which is also used to anchor the heating element (6) via two cover plates (5 and 10) that are heat-resistant, but also a printed circuit (7) that makes it possible to reduce the electrical wiring of the device to a minimum. A flexible scraper blade (3) is clamped between the shell (1) and the protective slide (4). The power is supplied by an electrical cable (8) and a cigarette lighter outlet (9). A switch (2) opens and closes the electrical circuit.

In variants that are not shown, the power supply via a cable (8) and an outlet (9) is replaced by an accumulator placed in a housing or, the handle is replaced by (sic) an electrical accumulator shaped like a handle that clips onto an electrical coupling base serving as an outlet for the handle-accumulator. This accumulator is kept in place by a snap hook system that ensures the stability of the handle and the correct connection with the electrical terminals.

In another variant, the power supply may be from the mains (conventional voltage) to allow use on display windows, window panes, windows and for cleaning freezers. It is enlarged for working on a larger surface as a result of large-scale use.

1) A portable device for defrosting surfaces covered with frost characterized by the fact that it comprises, as a result of its shell (1), a bell between the windshield and the device, where the temperature is high enough to melt the frost.

2) Device as claimed in claim 1, wherein the temperature is sufficiently heated beneath the shell (1) by a heating element (6) which is mounted on a protective slide (4) by two heat-resistant caches (5 and 10). The combination of this system with a flexible scraper blade placed perpendicular to the direction of movement (12) makes it possible to remove the melted frost or ice residue. Combining a heated bubble (1+6) and a flexible scraper blade on the same side and that are positioned to work in the same direction makes it possible to operate a full defrosting in a single pass over the entire width of the device. The heating element (6) is supplied with power via the cigarette lighter outlet (9) of the vehicle. The power is transmitted from the outlet (9) to the heating element (6) by a cable (8). A switch (2) opens and closes the electrical circuit of the device. To hold and use the device, the user has a handle provided for this purpose.

3) Device as claimed in claim 1 to claim 2, wherein the heating element (6) is located at a certain distance from the windshield to allow the ice to pass between the resistor and the surface to be defrosted. This adjustment is made via the cover (1) that also serves as a guiding device due to its shape.

4) Device as claimed in claim 1 to claim 3, wherein the power may also be supplied by connection to the electrical circuit of vehicles (8 and 9), to the mains (conventional voltage) or to a rechargeable battery.

5) Device as claimed in claim 1 to claim 4, wherein the elements of the electrical system are consolidated in a printed circuit (7) in order to reduce the electrical wiring of the device to a minimum.

6) Device as claimed in claim 1 to claim 5, wherein the shell (1) and the handle (11) are designed to make it possible to wrap the power cable (8) around the handle (11) or the shell (1).

7) Device as claimed in claim 1 to claim 6, wherein the width of the device can be increased to allow defrosting of a larger surface in a single pass.

8) Device as claimed in claim 1 to claim 7, wherein the heating element (6) is protected by protective cover plates to prevent contact between the user and the heating element (6). The cover plates system may be automatic or manual.
